(19) United States
(12) Patent Application Publication
(10) Pub. No.: US 2026/0164203 A1
(43) Pub. Date: Jun. 11, 2026

(54) TARGET RESPONSE CURVE DATA, TARGET RESPONSE CURVE DATA GENERATION METHOD, SOUND EMITTING DEVICE, SOUND PROCESSING DEVICE, SOUND DATA, ACOUSTIC SYSTEM, TARGET RESPONSE CURVE DATA GENERATION SYSTEM, PROGRAM, AND RECORDING MEDIUM

(71) Applicant: FINAL INC., Kanagawa (JP)

(72) Inventors: Kimio HAMASAKI, Kanagawa (JP); Mitsuru HOSOO, Kanagawa (JP)

(21) Appl. No.: 19/122,568

(22) PCT Filed: Oct. 21, 2022
(86) PCT No.: PCT/JP2022/039417

§ 371 Date: Apr. 18, 2025

(51) Int. Cl. H04S 7/00

(52) U.S. Cl. CPC H04S 7/301; H04S 2400/11; H04S 2400/13; H04S 2400/15

(57) ABSTRACT

A computer emits test sounds through headphones for each frequency band divided from an audible range. The computer acquires the sounds from a microphone placed proximate a listener. Based on the amplitude values of the acquired sounds for each frequency band, the computer represents the amplitude frequency characteristic of the full audible range as curve A. Additionally, for each frequency band dividing the audible range, the computer alternately emits a reference test sound and a comparison test sound from the headphones. The listener adjusts the sound pressure of the comparison test sound so that it is perceived equally loud as the reference test sound. The computer represents the amplitude frequency characteristic of the full audible range, as indicated by the variation amounts in sound pressure for each frequency band resulting from the adjustments, as curve B. The computer adds curve A and curve B to generate a target response curve.

### CROSS REFERENCE TO RELATED APPLICATIONS

This application is a 371 U.S. National Phase of International Application No. PCT/JP2022/039417, filed on Oct. 21, 2022. The entire disclosure of the above application is incorporated herein by reference.

### TECHNICAL FIELD

The present invention relates to acoustic technology, and more specifically to a target response curve.

### BACKGROUND ART

An amplitude frequency characteristic of sound emitted by a sound emitting device, such as earphones or headphones, affects an impression of the emitted sound perceived by the listener. Therefore, manufacturers of sound emitting devices design target response curves that define amplitude frequency characteristics likely to impart a favorable impression to the listener.

For example, one widely known target response curve is the so-called “Harman target response curve.” The Harman target response curve is a target response curve created based on a reference listening room of Harman International, a company within the Harman group. According to experiments conducted by Harman, sound corrected based on the Harman target response curve has been shown to impart a more favorable impression to listeners compared to sound corrected based on target response curves created with reference to an anechoic chamber or a reverberation chamber.

A patent document disclosing a technology utilizing a target response curve is, for example, JP2001-224100A. In the invention described in JP2001-224100A, graphic equalization is performed on an audio signal input to a speaker, so that sound is emitted with an amplitude frequency characteristic according to a target response curve selected by a listener from among a plurality of target response curves.

In recent years, immersive sound (spatial sound), which is intended to be emitted from multi-channel (three channels or more) speakers spatially arranged around the listener, has become increasingly common. A form of such immersive sound, known as immersive binaural sound, converts the spatial sound so that when the sound is emitted from a sound emitting device such as headphones or earphones that emit sound proximate to the listener's left and right external auditory canals, the listener perceives the sound as spatial sound.

Hereinafter, for convenience of explanation, sound emitting devices that emit sound proximate to the listener's left and right external auditory canals, such as headphones and earphones, or sound emitting devices that simulate such sound emission using a speaker array or similar components, will collectively be referred to as “external auditory canal sound emitting devices” in the present embodiment.

Conventionally, target response curves have been adjusted to impart a favorable impression to the listener when applied to two-channel stereo sound. Therefore, when immersive binaural sound is played using an external auditory canal sound emitting device that has an amplitude frequency characteristic in accordance with a conventional target response curve, a problem arises in that three-dimensional aspects of the sound, such as sound image localization direction and a perceived distance within the sound source's three-dimensional space, spatial width and directional perception arising from a combination of multiple sound sources (composite sound sources), and even a sense of spatial spread caused by reflected sound, are not faithfully reproduced as intended by a creator of the original sound source.

In view of the above circumstances, the present invention provides a means for reducing a difference between a three-dimensional acoustic space impression intended by the creator of the original immersive sound (spatial sound) source, and a three-dimensional acoustic space impression perceived by the listener when immersive binaural sound is emitted from an external auditory canal sound emitting device.

### SUMMARY

In a 1st aspect, the present invention provides target response curve data comprising: an amplitude frequency characteristic corrected in accordance with human auditory perception, so that a spatial impression intended by a creator of a sound source is reproduced when immersive binaural sound is played back through headphones or earphones, wherein acoustic characteristics are configured such that spatial blanking is performed to remove components contributing to a perception of sound directionality recognized by a human, and timbre recognition characteristics for recognizing a timbre of sound by the human brain are maintained.

In a 2nd aspect, the present invention provides a method for generating target response curve data comprising: correcting an amplitude frequency characteristic in accordance with human auditory perception so that a spatial impression intended by a creator of a sound source is reproduced when immersive binaural sound is played back through headphones or earphones, wherein the method includes performing spatial blanking to remove components contributing to a perception of sound directionality recognized by a human, and configuring acoustic characteristics such that timbre recognition characteristics for recognizing a timbre of sound by the human brain are maintained.

In a 3rd aspect, the present invention provides a sound emitting device manufactured with reference to a target response curve comprising an amplitude frequency characteristic corrected in accordance with human auditory perception, so that a spatial impression intended by a creator of a sound source is reproduced when immersive binaural sound is played back through headphones or earphones, wherein spatial blanking is performed to remove components contributing to a perception of sound directionality recognized by a human, and acoustic characteristics are configured such that timbre recognition characteristics for recognizing a timbre of sound by the human brain are maintained.

In a 4th aspect, the present invention provides a sound processing device that corrects an amplitude frequency characteristic of sound in accordance with a target response curve comprising an amplitude frequency characteristic corrected in accordance with human auditory perception, so that a spatial impression intended by a creator of a sound source is reproduced when immersive binaural sound is played back through headphones or earphones, wherein spatial blanking is performed to remove components contributing to a perception of sound directionality recognized by a human, and acoustic characteristics are configured such that timbre recognition characteristics for recognizing a timbre of sound by the human brain are maintained.

In a 5th aspect, the present invention provides a program for causing a computer to execute processing for correcting an amplitude frequency characteristic of sound in accordance with a target response curve comprising an amplitude frequency characteristic corrected in accordance with human auditory perception, so that a spatial impression intended by a creator of a sound source is reproduced when immersive binaural sound is played back through headphones or earphones, wherein spatial blanking is performed to remove components contributing to a perception of sound directionality recognized by a human, and acoustic characteristics are configured such that timbre recognition characteristics for recognizing a timbre of sound by the human brain are maintained.

In a 6th aspect, the present invention provides a method for generating target response curve data, wherein acoustic characteristics are configured to remove components contributing to a perception of sound directionality generated by an outer shape including at least a head of a human, and to maintain timbre recognition characteristics recognized by the human brain.

In a 7th aspect, the present invention provides the method for generating target response curve data according to the 6th aspect, comprising: a step of acquiring acoustic characteristics of sound from an external auditory canal through to an eardrum of a test listener; a step of acquiring sound pressure adjustment characteristics whereby the test listener perceives a loudness of sound as uniform across a full audible range; and a step of generating target response curve data based on the acoustic characteristics and the sound pressure adjustment characteristics.

In a 8th aspect, the present invention provides the method for generating target response curve data according to the 7th aspect, wherein the step of acquiring the acoustic characteristics includes generating curve A data representing an amplitude frequency characteristic of sound picked up proximate to the eardrum of the test listener while test sound is emitted proximate to the external auditory canal of the test listener; the step of acquiring the sound pressure adjustment characteristics includes generating curve B data representing an amplitude frequency characteristic based on variation amounts in sound pressure across a plurality of frequency bands, wherein the test listener adjusts a sound pressure of each of the plurality of frequency bands other than a reference frequency band so that each of the plurality of frequency bands is perceived to have a same loudness as that of the reference frequency band when band-limited pink noise obtained by dividing full audible range pink noise is sequentially emitted at a reference sound pressure proximate to the external auditory canal of the test listener; and the step of generating the target response curve data includes generating curve X data representing an amplitude frequency characteristic obtained by adding the amplitude frequency characteristic represented by the curve A data and the amplitude frequency characteristic represented by the curve B data, as the target response curve data for the test listener.

In a 9th aspect, the present invention provides the method for generating target response curve data according to the 8th aspect, further comprising: a step of generating curve Y data, as general purpose target response curve data, by averaging the amplitude frequency characteristics represented by the curve X data generated for each of a plurality of test listeners.

In a 10th aspect, the present invention provides the method for generating target response curve data according to the 7th aspect, wherein the step of acquiring the acoustic characteristics includes, for each of the plurality of test listeners, generating curve A data representing an amplitude frequency characteristic of sound picked up proximate to the eardrum of the test listener while test sound is emitted proximate to the external auditory canal of the test listener, and generating general purpose curve A data by averaging the amplitude frequency characteristics represented by the generated curve A data; the step of acquiring the sound pressure adjustment characteristics includes, for each of the plurality of test listeners, generating curve B data representing an amplitude frequency characteristic based on variation amounts in sound pressure across a plurality of frequency bands, wherein the test listener adjusts the sound pressure of each of the plurality of frequency bands other than a reference frequency band so that each of the plurality of frequency bands is perceived to have the same loudness as that of the reference frequency band when band-limited pink noise obtained by dividing full audible range pink noise is sequentially emitted at a reference sound pressure proximate to the external auditory canal of the test listener, and generating general-purpose curve B data by averaging the amplitude frequency characteristics represented by the generated curve B data; and the step of generating the target response curve data includes generating curve Y data, as general purpose target response curve data, representing an amplitude frequency characteristic obtained by adding the amplitude frequency characteristic represented by the general purpose curve A data and the amplitude frequency characteristic represented by the general purpose curve B data.

In a 11th aspect, the present invention provides the method for generating target response curve data according to the 7th aspect, wherein the step of acquiring acoustic characteristics includes generating curve A data representing an amplitude frequency characteristic of sound picked up proximate to the eardrum of the test listener while test sound is emitted proximate to the external auditory canal of the test listener by an external auditory canal sound emitting device; the step of acquiring sound pressure adjustment characteristics includes generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data, or a similar type of external auditory canal sound emitting device, the test listener adjusts the sound pressure of each of the plurality of frequency bands other than a reference frequency band so that each of the plurality of frequency bands is perceived to have the same loudness as that of the reference frequency band; and the step of generating the target response curve data includes generating curve X data representing an amplitude frequency characteristic obtained by adding the amplitude frequency characteristic represented by the curve A data and the amplitude frequency characteristic represented by the curve B data, as target response curve data for the same or similar type of external auditory canal sound emitting device used in generating the curve A data and the curve B data for the test listener.

In a 12th aspect, the present invention provides the method for generating target response curve data according to the 11th aspect, further comprising: a step of generating curve Y data, as general purpose target response curve data for the same or similar type of external auditory canal sound emitting device used in generating the curve X data, by averaging the amplitude frequency characteristics represented by the curve X data generated for each of a plurality of test listeners.

In a 13th aspect, the present invention provides the method for generating target response curve data according to the 7th aspect, wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener by an external auditory canal sound emitting device, and generating general purpose curve A data by averaging the amplitude frequency characteristics represented by the generated curve A data; the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data or a similar type of external auditory canal sound emitting device, the test listener adjusts the sound pressure of each of the plurality of frequency bands other than a reference frequency band so that each of the plurality of frequency bands is perceived to have the same loudness as that of the reference frequency band, and generating general purpose curve B data by averaging the amplitude frequency characteristics represented by the generated curve B data; and the step of generating the target response curve data includes generating curve Y data representing an amplitude frequency characteristic obtained by adding the amplitude frequency characteristic represented by the general purpose curve A data and the amplitude frequency characteristic represented by the general purpose curve B data, as general purpose target response curve data for the same or similar type of external auditory canal sound emitting device used in generating the curve A data and the curve B data.

In a 14th aspect, the present invention provides the method for generating target response curve data according to the 7th aspect, wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener; the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing full audible range pink noise is sequentially emitted at a reference sound pressure proximate to the external auditory canal of the test listener, the test listener adjusts the sound pressure of each of the plurality of frequency bands other than a reference frequency band so that each of the plurality of frequency bands is perceived to have the same loudness as that of the reference frequency band; and the step of generating the target response curve data includes generating curve Y data representing an amplitude frequency characteristic obtained by adding all the amplitude frequency characteristics represented by the curve A data and the curve B data of each of the plurality of test listeners and averaging the sum by the number of test listeners, as general purpose target response curve data.

In a 15th aspect, the present invention provides the method for generating target response curve data according to the 7th aspect, wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener by an external auditory canal sound emitting device; the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data or a similar type of external auditory canal sound emitting device, the test listener adjusts the sound pressure of each of the plurality frequency bands other than a reference frequency band so that each of the plurality of frequency bands is perceived to have the same loudness as that of the reference frequency band; and the step of generating the target response curve data includes generating curve Y data representing an amplitude frequency characteristic obtained by adding all the amplitude frequency characteristics represented by the curve A data and the curve B data of each of the plurality of test listeners and averaging the sum by the number of test listeners, as general purpose target response curve data for the same or similar type of external auditory canal sound emitting device used in generating the curve A data and the curve B data.

In a 16th aspect, the present invention provides the method for generating target response curve data according to any one of the 8th, 10th, 11th, 13th, 14th, and 15th aspects, wherein the test sound is band-limited pink noise obtained by dividing the full audible range pink noise into a plurality of frequency bands.

In a 17th aspect, the present invention provides the method for generating target response curve data according to any one of the 8th, 10th, 11th, 13th, 14th, and 15th aspects, wherein the test sound is an impulse.

In a 18th aspect, the present invention provides the method for generating target response curve data according to any one of the 8th, 10th, 11th, 13th, 14th, and 15th aspects, wherein the test sound is a sweep signal in which the frequency changes continuously or intermittently within the full audible range.

In a 19th aspect, the present invention provides the method for generating target response curve data according to any one of the 8th, 10th, 11th, 13th, 14th, and 15th aspects, wherein the reference frequency band is a frequency band centered at 500 Hz.

In a 20th aspect, the present invention provides the method for generating target response curve data according to any one of the 8th, 10th, 11th, 13th, 14th, and 15th aspects, wherein the reference sound pressure is 65 dB PSL.

In a 21st aspect, the present invention provides the method for generating target response curve data according to any one of the 8th, 10th, 11th, 13th, 14th, and 15th aspects, wherein the bandwidth of each of the plurality of frequency bands is one-third octave.

In a 22nd aspect, the present invention provides target response curve data, wherein acoustic characteristics are configured by removing components contributing to perception of sound directionality generated by an outer shape including at least the head of a human, and maintain timbre recognition characteristics recognized by the human brain.

In a 23rd aspect, the present invention provides a sound emitting device that emits sound having an amplitude frequency characteristic in accordance with a target response curve, wherein the acoustic characteristics are configured by removing components contributing to a perception of sound directionality generated by an outer shape including at least a head of a human, and to maintain timbre recognition characteristics recognized by the human brain.

In a 24th aspect, the present invention provides a sound emitting device comprising: a sound correction section configured to correct input sound in accordance with a target response curve in which acoustic characteristics are set by removing components contributing to a perception of sound directionality generated by an outer shape including at least a head of a human, and to maintain timbre recognition characteristics recognized by the human brain; and a sound emission section that emits the sound corrected by the sound correction section.

In a 25th aspect, the present invention provides the sound emitting device according to the 23rd or 24th aspect, wherein the sound emitting device is any one of headphones, earphones, a headrest speaker, or a speaker system that generates a virtual sound source.

In a 26th aspect, the present invention provides the sound emitting device according to the 24th aspect, comprising: an acquisition section configured to acquire target response curve data representing a target response curve; and a storage section configured to store the target response curve data acquired by the acquisition section, wherein the sound correction section corrects input sound in accordance with the target response curve represented by the target response curve data stored in the storage section.

In a 27th aspect, the present invention provides a sound processing device comprising: a sound correction section configured to correct input sound in accordance with a target response curve in which acoustic characteristics are set by removing components contributing to a perception of sound directionality generated by an outer shape including at least a head of a human, and to maintain timbre recognition characteristics recognized by the human brain.

In a 28th aspect, the present invention provides the sound processing device according to the 27th aspect, comprising: an acquisition section configured to acquire target response curve data representing a target response curve; and a storage section configured to store the target response curve data acquired by the acquisition section, wherein the sound correction section corrects input sound in accordance with the target response curve represented by the target response curve data stored in the storage section.

In a 29th aspect, the present invention provides a program for causing a computer to execute: processing for correcting input sound in accordance with a target response curve in which acoustic characteristics are set by removing components contributing to a perception of sound directionality generated by an outer shape including at least a head of a human, and to maintain timbre recognition characteristics recognized by the human brain.

In a 30th aspect, the present invention provides a recording medium storing a program for causing a computer to execute: processing for correcting input sound in accordance with a target response curve in which acoustic characteristics are set by removing components contributing to a perception of sound directionality generated by an outer shape including at least a head of a human, and to maintain timbre recognition characteristics recognized by the human brain.

In a 31st aspect, the present invention provides sound data representing sound that is corrected, with respect to a source sound, in accordance with a target response curve in which acoustic characteristics are set by removing components contributing to a perception of sound directionality generated by an outer shape including at least a head of a human, and to maintain timbre recognition characteristics recognized by the human brain.

In a 32nd aspect, the present invention provides a recording medium storing sound data representing sound that is corrected, with respect to a source sound, in accordance with a target response curve in which acoustic characteristics are set by removing components contributing to a perception of sound directionality generated by an outer shape including at least a head of a human, and to maintain timbre recognition characteristics recognized by the human brain.

In a 33rd aspect, the present invention provides an acoustic system comprising: a generation section configured to generate spatial audio content representing, for each of a plurality of sound sources, a sound source position and sound emitted by the sound source; a binaural rendering section configured to generate immersive binaural sound, which is two-channel spatial sound, using the spatial audio content generated by the generation section and a head-related transfer function; and a sound emission section configured to emit the immersive binaural sound generated by the binaural rendering section, wherein the sound emission section emits sound having an amplitude frequency characteristic in accordance with a target response curve in which acoustic characteristics are set by removing components contributing to a perception of sound directionality generated by an outer shape including at least a head of a human, and to maintain timbre recognition characteristics recognized by the human brain.

In a 34th aspect, the present invention provides an acoustic system comprising: a generation section configured to generate spatial audio content representing, for each of a plurality of sound sources, a sound source position and sound emitted by the sound source; a binaural rendering section configured to generate immersive binaural sound, which is two-channel spatial sound, using the spatial audio content generated by the generation section and a head-related transfer function; and a sound emission section configured to emit the immersive binaural sound generated by the binaural rendering section, wherein correction is performed in accordance with a target response curve, in which acoustic characteristics are set by removing components contributing to a perception of sound directionality generated by an outer shape including at least a head of a human, and to maintain timbre recognition characteristics recognized by the human brain, is performed in any of the generation section, the binaural rendering section, or the sound emission section.

In a 35th aspect, the present invention provides an acoustic system comprising: a generation section configured to generate spatial audio content representing, for each of a plurality of sound sources, a sound source position and sound emitted by the sound source; a binaural rendering section configured to generate immersive binaural sound, which is two-channel spatial sound, using the spatial audio content generated by the generation section and a head-related transfer function; a sound emission section configured to emit the immersive binaural sound generated by the binaural rendering section; and a sound processing device disposed in a sound transmission path from a sound generation section to a sound emission section, and configured to correct input sound in accordance with a target response curve in which acoustic characteristics are set by removing components contributing to a perception of sound directionality generated by an outer shape including at least a head of a human, and to maintain timbre recognition characteristics recognized by the human brain.

In a 36th aspect, the present invention provides the acoustic system according to any one of the 33rd to 35th aspects, wherein the generation section is a spatial audio content generation section, and the system further comprises: a video generation section configured to generate video representing a three-dimensional space in cross reality; and a display section configured to display the video generated by the video generation section, wherein the binaural rendering section generates spatial audio content using objects in the three-dimensional space shown in the video generated by the video generation section as sound sources.

In a 37th aspect, the present invention provides the acoustic system according to any one of the 33rd to 35th aspects, wherein the generation section continuously acquires a sound source position of a moving sound source, and generates spatial audio content representing the sound source position.

In a 38th aspect, the present invention provides the acoustic system according to the 37th aspect, wherein the sound emission section emits sound proximate to the external auditory canal of a listener moving together with the moving sound source.

In a 39th aspect, the present invention provides a target response curve data generation system comprising: a sound output section configured to output sound to a sound emitting device that emits sound proximate to an external auditory canal of a test listener; a sound acquisition section configured to acquire sound picked up by a microphone disposed proximate to an eardrum of the test listener while the sound output section emits a test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness as equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the frequency bands as specified by the acquired operation signal; and a personal target response curve data generation section configured to generate curve X data representing an amplitude frequency characteristic obtained by adding the amplitude frequency characteristic represented by the curve A data and the amplitude frequency characteristic represented by the curve B data, as target response curve data for the test listener.

In a 40th aspect, the present invention provides a target response curve data generation system comprising: a sound output section configured to output sound to a sound emitting device that emits sound proximate to an external auditory canal of a test listener; a sound acquisition section configured to acquire sound picked up by a microphone attached to an end of an extremely fine tube made of a soft material inserted proximate to an eardrum of the test listener while the sound output section emits test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the frequency bands as specified by the acquired operation signal; and a personal target response curve data generation section configured to generate curve X data representing an amplitude frequency characteristic obtained by adding the amplitude frequency characteristic represented by the curve A data and the amplitude frequency characteristic represented by the curve B data, as target response curve data for the test listener.

In a 41st aspect, the present invention provides the target response curve data generation system according to the 39th or 40th aspect, further comprising: a general purpose target response curve data generation section configured to generate curve Y data, as general purpose target response curve data, by averaging the amplitude frequency characteristics represented by the target response curve data generated by the personal target response curve data generation section for each of a plurality of test listeners.

In a 42nd aspect, the present invention provides a target response curve data generation system comprising: a sound output section configured to output sound to a sound emitting device that emits sound proximate to an external auditory canal of a test listener; a sound acquisition section configured to acquire sound picked up by a microphone disposed proximate to an eardrum of the test listener while the sound output section emits a test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the plurality of frequency bands as specified by the acquired operation signal; and a general purpose target response curve data generation section configured to generate curve Y data, as general purpose target response curve data, by adding the average of the amplitude frequency characteristics represented by the curve A data generated for each of a plurality of test listeners and the average of the amplitude frequency characteristics represented by the curve B data generated for each of the plurality of test listeners.

In a 43rd aspect, the present invention provides a target response curve data generation system comprising: a sound output section configured to output sound to a sound emitting device that emits sound proximate to an external auditory canal of a test listener; a sound acquisition section configured to acquire sound picked up by a microphone attached to an end of an extremely fine tube made of a soft material inserted proximate to an eardrum of the test listener while the sound output section emits a test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness as equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the frequency bands as specified by the acquired operation signal; and a general purpose target response curve data generation section configured to generate curve Y data, as general purpose target response curve data, by adding the average of the amplitude frequency characteristics represented by the curve A data generated for each of a plurality of test listeners and the average of the amplitude frequency characteristics represented by the curve B data generated for each of the plurality of test listeners.

In a 44th aspect, the present invention provides a target response curve data generation system comprising: a sound output section configured to output sound to a sound emitting device that emits sound proximate to an external auditory canal of a test listener; a sound acquisition section configured to acquire sound picked up by a microphone disposed proximate to an eardrum of the test listener while the sound output section emits a test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness as equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the frequency bands as specified by the acquired operation signal; and a general-purpose target response curve data generation section configured to generate curve Y data, as general purpose target response curve data, by adding all the amplitude frequency characteristics represented by the curve A data and the curve B data of each of the plurality of test listeners, and averaging the sum by the number of test listeners.

In a 45th aspect, the present invention provides a target response curve data generation system comprising: a sound output section configured to output sound to a sound emitting device that emits sound proximate to an external auditory canal of a test listener; a sound acquisition section configured to acquire sound picked up by a microphone attached to an end of an extremely fine tube made of a soft material inserted proximate to an eardrum of the test listener while the sound output section emits a test sound through the sound emitting device; a curve A data generation section configured to generate curve A data representing an amplitude frequency characteristic of the acquired sound; a notification section configured to prompt the test listener, while the sound output section sequentially outputs each of a plurality of band-limited pink noise signals obtained by dividing full audible range pink noise into frequency bands to the sound emitting device at a reference sound pressure, to adjust, using an operation device, a sound pressure of each frequency band other than a reference frequency band so that the listener perceives a loudness as equal to that of the reference frequency band; an operation signal acquisition section configured to acquire an operation signal corresponding to the adjustment operation by the test listener via the operation device; a curve B data generation section configured to generate curve B data representing an amplitude frequency characteristic based on the variation amounts of sound pressure across the frequency bands as specified by the acquired operation signal; and a general purpose target response curve data generation section configured to generate curve Y data, as general purpose target response curve data, by adding all the amplitude frequency characteristics represented by the curve A data and the curve B data of each of the plurality of test listeners, and averaging the sum by the number of test listeners.

In a 46th aspect, the present invention provides the target response curve data generation system according to any one of the 39th, 40th, 42nd, 43rd, 44th, and 45th aspects, wherein the test sound is band-limited pink noise obtained by dividing full audible range pink noise into a plurality of frequency bands.

In a 47th aspect, the present invention provides the target response curve data generation system according to any one of the 39th, 40th, 42nd, 43rd, 44th, and 45th aspects, wherein the test sound is an impulse.

In a 48th aspect, the present invention provides the target response curve data generation system according to any one of the 39th, 40th, 42nd, 43rd, 44th, and 45th aspects, wherein the test sound is a sweep signal in which the frequency changes continuously or intermittently within the audible range.

In a 49th aspect, the present invention provides the target response curve data generation system according to any one of the 39th, 40th, 42nd, 43rd, 44th, and 45th aspects, wherein the reference frequency band is a frequency band centered at 500 Hz.

In a 50th aspect, the present invention provides the target response curve data generation system according to any one of the 39th, 40th, 42nd, 43rd, 44th, and 45th aspects, wherein the reference sound pressure is 65 dB PSL.

In a 51st aspect, the present invention provides the target response curve data generation system according to any one of the 39th, 40th, 42nd, 43rd, 44th, and 45th aspects, wherein the bandwidth of each of the plurality of frequency bands is one-third octave.

In a 52nd aspect, the present invention provides a program for causing a computer to execute: a process of outputting a test sound to a sound emitting device that emits sound proximate to an external auditory canal of a test listener; a process of acquiring sound picked up by a microphone disposed proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band such that the test listener perceives a loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve X data, representing an amplitude frequency characteristic obtained by adding the amplitude frequency characteristic represented by the curve A data and the amplitude frequency characteristic represented by the curve B data, as target response curve data for the test listener.

In a 53rd aspect, the present invention provides a program for causing a computer to execute: a process of outputting a test sound to a sound emitting device that emits sound proximate to an external auditory canal of a test listener; a process of acquiring sound picked up by a microphone attached to an end of an extremely fine tube made of a soft material inserted proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band such that the test listener perceives the loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve X data, representing an amplitude frequency characteristic obtained by adding the amplitude frequency characteristic represented by the curve A data and the amplitude frequency characteristic represented by the curve B data, as target response curve data for the test listener.

In a 54th aspect, the present invention provides the program according to the 52nd or 53rd aspect, wherein the computer is further caused to execute a process of generating curve Y data, as general purpose target response curve data, by averaging the amplitude frequency characteristics represented by the curve X data generated for each of a plurality of test listeners.

In a 55th aspect, the present invention provides a program for causing a computer to execute: a process of outputting a test sound to a sound emitting device that emits sound proximate to an external auditory canal of a test listener; a process of acquiring sound picked up by a microphone disposed proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band such that the test listener perceives a loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve Y data, as general purpose target response curve data, by adding the average of the amplitude frequency characteristics represented by the curve A data generated for each of a plurality of test listeners and the average of the amplitude frequency characteristics represented by the curve B data generated for each of the plurality of test listeners.

In a 56th aspect, the present invention provides a program for causing a computer to execute: a process of outputting a test sound to a sound emitting device that emits sound proximate to an external auditory canal of a test listener; a process of acquiring sound picked up by a microphone attached to an end of an extremely fine tube made of a soft material inserted proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band, such that the test listener perceives a loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve Y data, as general purpose target response curve data, by adding the average of the amplitude frequency characteristics represented by the curve A data generated for each of a plurality of test listeners and the average of the amplitude frequency characteristics represented by the curve B data generated for each of the plurality of test listeners.

In a 57th aspect, the present invention provides a program for causing a computer to execute: a process of outputting a test sound to a sound emitting device that emits sound proximate to an external auditory canal of a test listener; a process of acquiring sound picked up by a microphone disposed proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band such that the test listener perceives a loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve Y data, as general purpose target response curve data, by adding all of the amplitude frequency characteristics represented by the curve A data and the curve B data of each of a plurality of test listeners, and averaging the sum by the number of the test listeners.

In a 58th aspect, the present invention provides a program for causing a computer to execute: a process of outputting a test sound to a sound emitting device that emits sound proximate to an external auditory canal of a test listener; a process of acquiring sound picked up by a microphone attached to an end of an extremely fine tube made of a soft material inserted proximate to an eardrum of the test listener while the test sound is being output; a process of generating curve A data representing an amplitude frequency characteristic of the acquired sound; a process of sequentially outputting each of a plurality of band-limited pink noise signals, obtained by dividing full audible range pink noise into frequency bands, to the sound emitting device at a reference sound pressure; a process of outputting a notification to a notification device that notifies the test listener, in parallel with the outputting of the band-limited pink noise, to perform an operation on an operation device to adjust a sound pressure of each frequency band other than a reference frequency band, such that the test listener perceives a loudness as equal to that of the band-limited pink noise corresponding to the reference frequency band; a process of acquiring an operation signal corresponding to the operation performed by the test listener on the operation device in response to the notification; a process of generating curve B data representing an amplitude frequency characteristic based on variation amounts of sound pressure in the plurality of frequency bands derived from the acquired operation signal; and a process of generating curve Y data, as general purpose target response curve data, by adding all of the amplitude frequency characteristics represented by the curve A data and the curve B data of each of a plurality of test listeners, and averaging the sum by the number of the test listeners.

In a 59th aspect, the present invention provides the program according to any one of the 52nd, 53rd, 55th, 56th, 57th, and 58th aspects, wherein the test sound is band-limited pink noise obtained by dividing full audible range pink noise into a plurality of frequency bands.

In a 60th aspect, the present invention provides the program according to any one of the 52nd, 53rd, 55th, 56th, 57th, and 58th aspects, wherein the test sound is an impulse.

In a 61st aspect, the present invention provides the program according to any one of the 52nd, 53rd, 55th, 56th, 57th, and 58th aspects, wherein the test sound is a sweep signal in which the frequency changes continuously or intermittently within the audible range.

In a 62nd aspect, the present invention provides the program according to any one of the 52nd, 53rd, 55th, 56th, 57th, and 58th aspects, wherein the reference frequency band is a frequency band centered at 500 Hz.

In a 63rd aspect, the present invention provides the program according to any one of the 52nd, 53rd, 55th, 56th, 57th, and 58th aspects, wherein the reference sound pressure is 65 dB PSL.

In a 64th aspect, the present invention provides the program according to any one of the 52nd, 53rd, 55th, 56th, 57th, and 58th aspects, wherein the bandwidth of each of the plurality of frequency bands is one-third octave.

### ADVANTAGES OF THE INVENTION

When immersive binaural sound is emitted from an external auditory canal sound emitting device having the amplitude frequency characteristic indicated by the target response curve data according to the present invention, the listener is able to perceive a three-dimensional acoustic space impression closer to the impression intended by the creator of the sound source of the immersive binaural sound, as compared with a case where a conventional external auditory canal sound emitting device is used.

### BRIEF DESCRIPTION OF THE DRAWINGS

FIG. 1 shows the configuration of a target response curve data generation system according to an exemplary embodiment of the present invention.

FIG. 2 shows the configuration of a data processing device for generating curve A data according to an exemplary embodiment of the present invention.

FIG. 3 shows an example of a processing flow performed by the data processing device to generate curve A data according to an exemplary embodiment of the present invention.

FIG. 4 shows the configuration of a data processing device for generating curve B data according to an exemplary embodiment of the present invention.

FIG. 5 shows an example of a processing flow performed by the data processing device to generate curve B data according to an exemplary embodiment of the present invention.

FIGS. 6A and 6B illustrate a user interface displayed by the data processing device according to an exemplary embodiment of the present invention.

FIG. 7 shows the configuration of a data processing device for generating curve X data according to an exemplary embodiment of the present invention.

FIG. 8 shows an example of a processing flow performed by the data processing device to generate curve X data according to an exemplary embodiment of the present invention.

FIG. 9 shows the configuration of a data processing device for generating curve Y data according to an exemplary embodiment of the present invention.

FIG. 10 shows an example of a processing flow performed by the data processing device to generate curve Y data according to an exemplary embodiment of the present invention.

FIG. 11 is a graph showing a target response curve generated by the data processing device and a target response curve created based on an anechoic chamber according to an exemplary embodiment of the present invention.

FIG. 12 shows the configuration of an acoustic system according to an exemplary embodiment of the present invention.

FIG. 13 shows the configuration of an audiovisual system according to a modified example of the present invention.

### DETAILED DESCRIPTION

### Exemplary Embodiment

An exemplary embodiment of the present invention will now be described below with respect to the target response curve data.

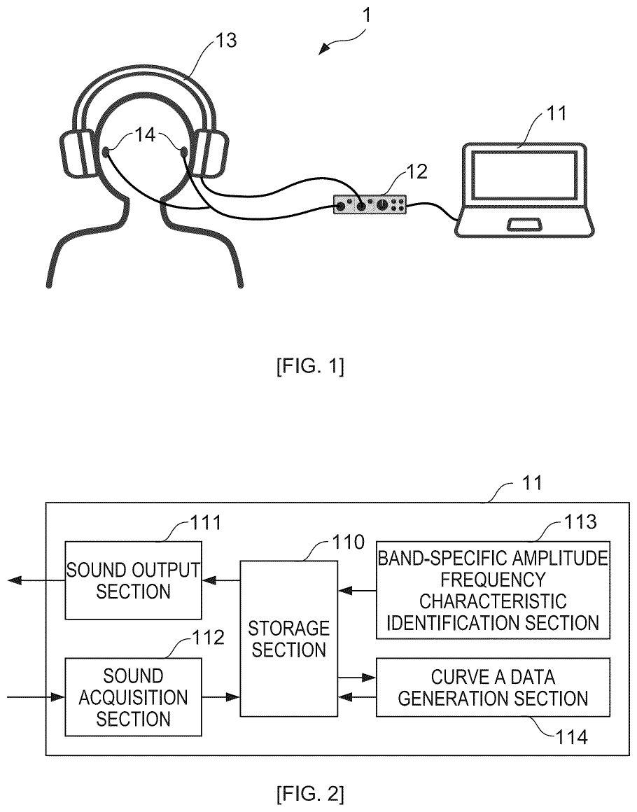

A target response curve data generation system 1 is a system for generating the target response curve data according to the exemplary embodiment of the present invention. FIG. 1 shows the configuration of the target response curve data generation system 1. The target response curve data generation system 1 includes a computer 11, an audio interface 12 connected to the computer 11, headphones 13 connected to the audio interface 12, and a microphone 14 connected to the audio interface 12.

The computer 11 includes a memory for storing various types of data including programs, a processor that performs data processing in accordance with the program stored in the memory, a display that displays, under control of the processor, information to a user acting as a test listener, and an operation device (e.g., keyboard and mouse) that receives user input, and outputs corresponding signals to the processor.

It is of note that one or more of the memory, display, or operation device may be externally connected devices with respect to the main body of the computer 11, which includes at least the processor and part of the memory. Alternatively, the computer 11 may include a composite device such as a touchscreen that integrates the display and the operation device.

The audio interface 12 is a device that functions both as a D/A (Digital to Analog) converter that converts digital sound data input from the computer 11 into analog audio signals for output to the headphones 13, and as an A/D (Analog to Digital) converter that converts analog audio signals input from the microphone 14 into digital sound data for output to the computer 11.

The headphones 13 are sound-emitting devices that emit sounds, represented by analog audio signals received from the audio interface 12, proximate to the user's left and right external auditory canals.

The microphone 14 is a sound pickup device disposed proximate to the user's left and right eardrums, which picks up sounds and outputs to the audio interface 12 analog audio signals representing the picked-up sounds.

For example, the microphone 14 may be a microphone attached to the end of an extremely fine tube made of a soft material, which is inserted proximate to the user's left and right eardrums.

The target response curve data generation system 1 generates data (curve Y data) representing a general-purpose target response curve, referred to as curve Y in the present embodiment, which is intended for a range of listeners (i.e., not limited to specific individuals). Broadly, generation of the curve Y data is carried out using the following steps:
(1) Generation of curve A data
(2) Generation of curve B data
(3) Generation of curve X data
(4) Generation of curve Y data

The order of steps (1) and (2) may be reversed. Step (3), which generates the curve X data, is performed after steps (1) and (2) since it uses the curve A data and the curve B data generated in those steps. Step (4), which generates the curve Y data, is then performed based on the curve X data generated at step (3).

### (1) Generation of Curve A Data

The following describes the operation performed by the target response curve data generation system 1 to generate the curve A data.

FIG. 2 shows the configuration of a data processing device (an example of a target response curve data generation system) implemented by the computer 11 for generating the curve A data. That is, by executing a program for generating curve A data, the computer 11 functions as a device having the components shown in FIG. 2.

The components shown in FIG. 2 will now be described. A storage section 110 stores various types of data. In the storage section 110, test sound data representing a waveform of each band-limited pink noise, obtained by dividing a full audible range pink noise into one-third octave bands, is stored in advance. The same test sound data is used consistently for multiple test listeners. The amplitude of the full audible range pink noise, which serves as the source of the test sound, may be set within a range that does not impose a burden on the test listener. In the present embodiment, the same test sound is used to generate both the curve A data and the curve B data. Therefore, the amplitude must be adjusted such that when a signal extracted at a one-third octave bandwidth centered at 500 Hz is played through the headphones, the sound pressure level proximate to the left or right eardrum of the test listener becomes 65 dB PSL. This level (65 dB PSL) corresponds to the sound pressure level proximate to the eardrum caused by the band-limited pink noise centered at 500 Hz during playback of the curve B data. The frequency bands of the multiple band-limited pink noise are referred to as the first frequency band, second frequency band, ..., nth frequency band, in ascending order of frequency. When the audible range (approximately 10 octaves) is divided into one-third octave bandwidths, there are approximately 30 frequency bands. This allows generation of curve A data with adequate precision without undesirably imposing an excessive burden on the test listener. The same applies to the pink noise used in generating the curve B data described later.

A sound output section 111 outputs to the audio interface 12 sound data representing the test sounds for generating the curve A data. In the present embodiment, the test sounds for generating the curve A data are band-limited pink noise, one for each of the n frequency bands from the first to the nth bands, stored in the storage section 110. For each of the n frequency bands, the sound output section 111 reads the test sound data from the storage section 110, generates two-channel (left and right identical) sound data representing the test sound, and outputs it to the audio interface 12.

A sound acquisition section 112 acquires, from the audio interface 12, sound data representing the sounds picked up by the left and right microphones 14 during playback of the test sound from the headphones 13, for each of the n frequency bands. The acquired sound data is temporarily stored in the storage section 110.

A band-specific amplitude frequency characteristic identification section 113 identifies, for each of the n frequency bands, the amplitude value of the left and right channel sounds represented by the sound data acquired by the sound acquisition section 112 and temporarily stored in the storage section 110. The band-specific amplitude frequency characteristic identification section 113 generates band-specific amplitude value data representing the identified amplitude values. The band-specific amplitude value data generated for each of the n frequency bands is also temporarily stored in the storage section 110.

The curve A data generation section 114 interpolates the band-specific amplitude value data (discrete values) temporarily stored in the storage section 110 for each of the n frequency bands, and identifies an amplitude frequency characteristic over the full audible range. The identified amplitude frequency characteristic is referred to as curve A. The curve A data generation section 114 generates curve A data representing the curve A. The generated curve A data is temporarily stored in the storage section 110. When the curve A data is plotted on a two-dimensional graph with amplitude (dB) on the vertical axis and frequency (Hz) on the horizontal axis, two curves A (amplitude frequency characteristics) one each for the left and right ears of the test listener can be visualized.

The curve A represents the acoustic characteristics of the sound from the test listener's external auditory canal through to the eardrum, and specific to the headphones used for measurement.

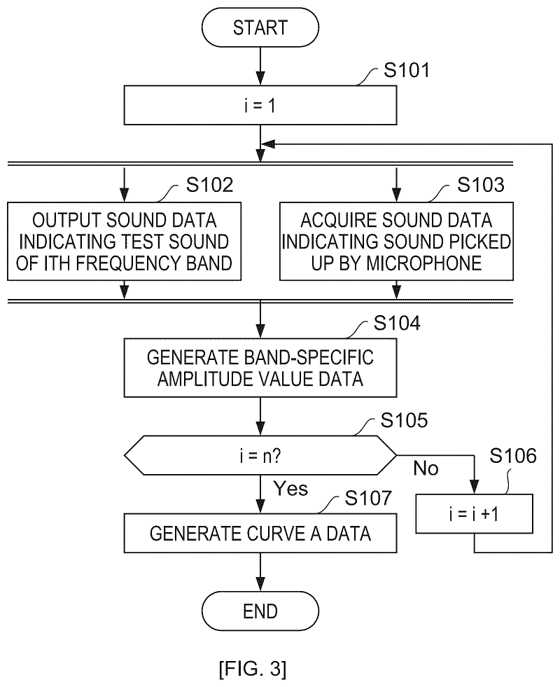

FIG. 3 shows an example of a processing flow performed by the computer 11 functioning as a device having the above configuration to generate curve A data. The processing according to the flow shown in FIG. 3 will be described below.

First, the computer 11 sets an initial value “1” to a counter i (step S101).

Next, the computer 11 (sound output section 111) outputs the sound data representing the test sound of the ith frequency band to the audio interface 12 (step S102). The audio interface 12 converts the sound data received from the computer 11 into an audio signal by D/A conversion and outputs the audio signal to the headphones 13. The headphones 13 emit sound represented by the audio signal received from the audio interface 12.

The computer 11 (sound acquisition section 112) acquires, in parallel with the processing at step S102, the sound data representing the sound picked up by the microphone 14 from the audio interface 12 (step S103).

Then, the computer 11 (band-specific amplitude frequency characteristic identification section 113) identifies the amplitude value of the sound represented by the sound data of the ith frequency band acquired at step S103, and generates band-specific amplitude value data representing the identified amplitude value (step S104). The computer 11 (storage section 110) temporarily stores the band-specific amplitude value data generated at step S104.

Next, the computer 11 determines whether the counter i equals n (step S105).

If the counter i is not equal to n (step S105; “No”), the computer 11 increments the counter i by one (step S106), and repeats the processing from step S102 and subsequent steps for the new ith frequency band.

If the counter i equals n (step S105; “Yes”), the computer 11 (curve A data generation section 114) interpolates the n band-specific amplitude value data (discrete values) temporarily stored, identifies the amplitude frequency characteristic over the full audible range, i.e., the curve A, and generates curve A data representing the identified curve A (step S107). The computer 11 (storage section 110) temporarily stores the curve A data generated at step S107. Thereafter, the computer 11 completes the series of processing for generating the curve A data.

### (2) Generation of Curve B Data

The operation performed by the target response curve data generation system 1 to generate the curve B data will now be described.

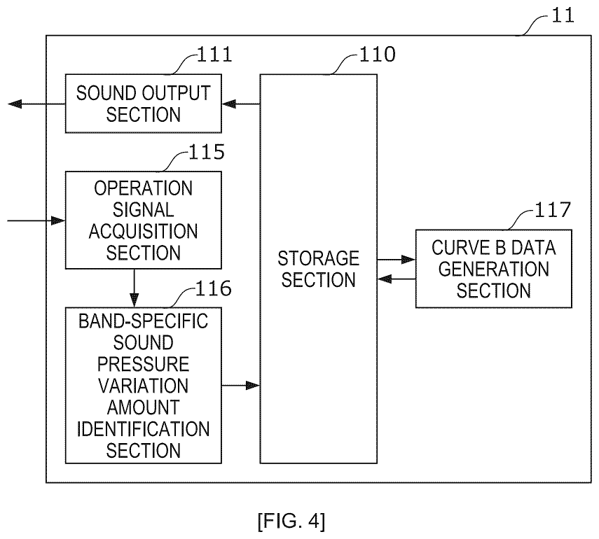

FIG. 4 shows the configuration of a data processing device (an example of the target response curve data generation system) implemented by the computer 11 when generating the curve B data. That is, by executing a program for generating the curve B data, the computer 11 functions as a device having the components shown in FIG. 4.

The components shown in FIG. 4 will now be described. In FIG. 4, components common to those shown in FIG. 2 are denoted by the same reference numerals used in FIG. 2.

The storage section 110 stores various types of data. The storage section 110 stores test sound data representing the waveform of band-limited pink noise for each of the n one-third octave bandwidth frequency bands from the first to the nth frequency bands.

The sound output section 111 outputs to the audio interface 12 sound data representing the test sound for generating the curve B data. In the present embodiment, the test sound for generating the curve B data is the same as the test sound used for generating the curve A data. That is, for each of the n frequency bands, the sound output section 111 reads the test sound data from the storage section 110, generates two-channel sound data (same sound for both left and right channels), and outputs the sound data to the audio interface 12.

The operation signal acquisition section 115 acquires operation signals generated by an operation device (e.g., a keyboard or mouse) of the computer 11 in response to a user input.

The band-specific sound pressure variation amount identification section 116 identifies, based on the operation signals acquired by the operation signal acquisition section 115, the variation amount in sound pressure level (dB SPL) when the test listener adjusts the sound pressure of comparison test sounds (i.e., test sounds for each of the frequency bands from the first to the nth bands, excluding the kth frequency band) such that a perceived loudness matches the loudness of a reference test sound of a reference frequency band (the kth frequency band).

In the present embodiment, the reference frequency band (kth frequency band) is the frequency band centered at 500 Hz. Since a loudness of sounds around 500 Hz is easily perceived by most listeners, it is easy to adjust a loudness of other test sounds to match the loudness of the reference sound. In addition, the sound pressure of the reference test sound is 65 dB PSL in the present embodiment. This level is neither too loud nor too soft for most listeners, making it easy to perform the loudness matching without imposing an undue burden on the listener.

The band-specific sound pressure variation amount identification section 116 generates sound pressure variation amount data representing the identified variation amount in sound pressure for each of the frequency bands from the first to the nth bands (excluding the kth frequency band). The generated sound pressure variation amount data is temporarily stored in the storage section 110.

The curve B data generation section 117 interpolates the sound pressure variation amounts (discrete values) represented by the sound pressure variation amount data temporarily stored in the storage section 110 for each of the n frequency bands (excluding the kth frequency band), and identifies the amplitude frequency characteristic over the full audible range. This identified amplitude frequency characteristic is referred to as curve B. The curve B data generation section 117 generates curve B data representing the curve B. The generated curve B data is temporarily stored in the storage section 110.

The curve B represents the sound pressure adjustment characteristics required for the test listener to perceive a constant loudness over the full audible range.

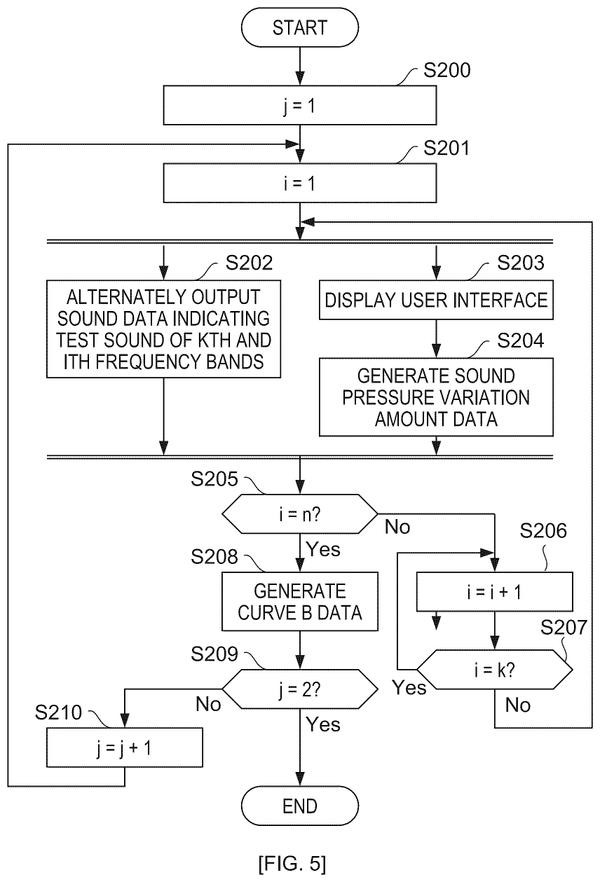

FIG. 5 shows an example of a processing flow performed by the computer 11, functioning as a device having the above configuration, to generate the curve B data. The processing according to the flow shown in FIG. 5 is described below.

First, the computer 11 sets the initial value of counter j to “1” (step S200). Then, the computer 11 sets the initial value of counter i to “1” (step S201).

Next, the computer 11 (sound output section 111) alternately outputs to the audio interface 12 the sound data representing the reference test sound and the sound data representing the comparison test sound for the ith frequency band (step S202). The audio interface 12 converts the sound data received from the computer 11 into audio signals by D/A conversion and outputs the audio signals to the headphones 13. The headphones 13 emit the sounds represented by the audio signals output from the audio interface 12.

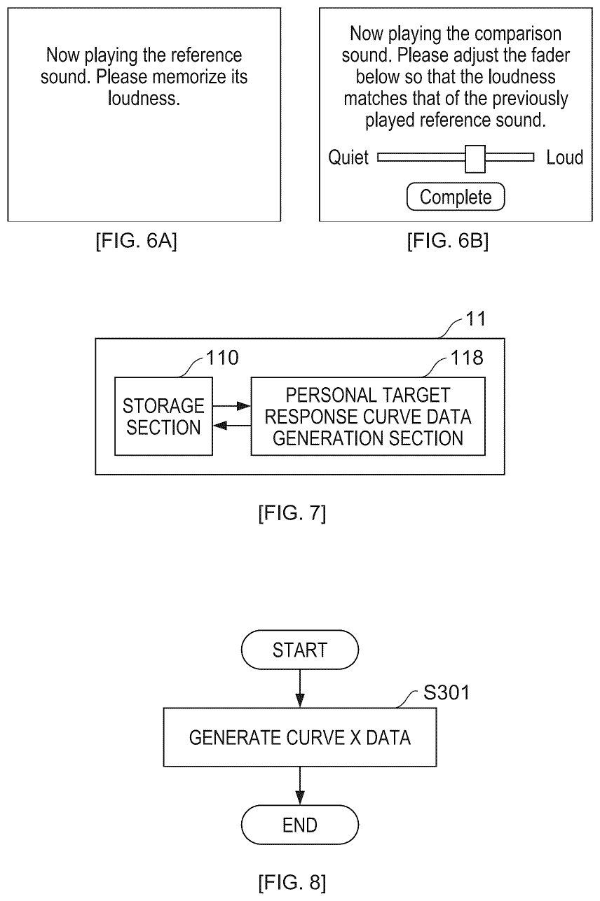

In parallel with the processing at step S202, the computer 11 displays a user interface such as that shown in FIGS. 6A and 6B on the display (notification device, an example of a notification section) (step S203).

FIG. 6A shows the user interface displayed by the computer 11 on the display while the sound data representing the reference test sound is being output to the audio interface 12 at step S202. That is, while the reference test sound is being emitted from the headphones 13, the computer 11 prompts the user to memorize the loudness of the reference test sound.

FIG. 6B shows the user interface displayed by the computer 11 on the display while the sound data representing the comparison test sound for the ith frequency band is being output to the audio interface 12 at step S202. That is, while the comparison test sound is being emitted from the headphones 13, the computer 11 prompts the user to operate a virtual controller (e.g., fader; hereinafter referred to as “fader” for convenience) such that the loudness of the comparison test sound is perceived to be equal to the memorized loudness of the reference test sound. The computer 11 accepts user input of an operation device for operating the fader. Based on the operation signal acquired from the operation device (e.g., the mouse), the computer 11 identifies the variation amount in sound pressure and adjusts the amplitude of the comparison test sound data output to the audio interface 12. Furthermore, the computer 11 accepts user input for a virtual “Complete” button displayed on the user interface a shown in FIG. 6B.

The computer 11 (operation signal acquisition section 115) acquires operation signals from the operation device (e.g., the mouse) when the user interacts with the user interface in FIG. 6B. If the acquired operation signal corresponds to the “Complete” button, the computer 11 (band-specific sound pressure variation amount identification section 116) generates sound pressure variation amount data representing the sound pressure variation amount of the comparison test sound, as indicated by the current position of the fader (FIG. 5, step S204). The computer 11 (storage section 110) temporarily stores the sound pressure variation amount data generated at step S204.

Next, the computer 11 determines whether counter i is equal to n (FIG. 5, step S205).

If counter i is not equal to n (step S205; “No”), the computer 11 increments counter i by one (step S206).

The computer 11 then determines whether counter i is equal to k (step S207).

If counter i is not equal to k (step S207; “No”), the computer 11 repeats the processing from step S202 and subsequent steps for the new ith frequency band.

If counter i is equal to k (step S207; “Yes”), the computer 11 skips steps S202 and S203 for that iteration and proceeds again from step S206. That is, step S206 is executed twice, thereby skipping the processing for the comparison test sound when the comparison test sound coincides with the reference test sound.

If counter i is equal to n in the determination of step S205 (step S205; “Yes”), the computer 11 (curve B data generation section 117) interpolates the (n−1) sound pressure variation amount data temporarily stored, identifies the amplitude frequency characteristic over the full audible range, i.e., curve B, and generates curve B data representing the identified curve B (step S208). The computer 11 (storage section 110) temporarily stores the curve B data generated at step S208.

The computer 11 then determines whether counter j is equal to 2 (step S209). If counter j is not equal to 2 (step S209; “No”), the computer 11 increments counter j by one (step S210) and repeats the processing from step S201. However, in the second execution of step S202, the comparison test sound is played back at the sound pressure obtained by adding the variation amount represented by the sound pressure variation amount data for the corresponding ith frequency band (as adjusted by the test listener in the first round) to 65 dB PSL.

That is, the test listener can confirm the results of their adjustments for each frequency band. If the test listener perceives a difference in loudness between the reference test sound and the comparison test sound for a particular frequency band, they can again adjust the amplitude for the comparison test sound data output to the audio interface 12 at steps S202 to S204, as in the first round.

After completion of the second execution of step S208, the computer 11 determines at step S209 that counter j is equal to 2 (step S209; “Yes”), and completes the series of processing for generating the curve B data. As a result, the desired curve B data is obtained.

The second execution of steps S202 to S208 is not mandatory but is preferably performed to enhance accuracy of the adjustments made by the test listener. In the above example, the process by which the comparison test sound transitions from the frequency band with the lowest frequency to that with the highest frequency at step S202 is repeated twice. However, the order in which the comparison test sounds are played back is not limited to this example. For instance, according to a variation embodiment, the adjustment of the loudness of each comparison test sound may begin from the kth frequency band (the reference test sound), then proceed to the (k−1)th, (k−2)th, ..., and down to the first frequency band, lowering the frequency each time to match the loudness with that of the reference test sound. Then, starting from the first frequency band, the adjustment may proceed upward in frequency to the (k−1)th frequency band, adjusting the sound pressure of the comparison test sound for each frequency band. Next, the adjustment may proceed from the (k+1)th to the nth frequency band in ascending order of frequency, and finally, from the nth to the (k+1)th frequency band in descending order of frequency, completing the series of processing.

### (3) Generation of Curve X Data

The following describes the operation performed by the target response curve data generation system 1 to generate the curve X data.

FIG. 7 shows the configuration of a data processing device (an example of a target response curve data generation system) implemented by the computer 11 for generating the curve X data. That is, the computer 11 functions as a device having the components shown in FIG. 7 by executing data processing according to a program for generating the curve X data.

The components shown in FIG. 7 will be described below. In FIG. 7, components common to those shown in FIG. 2 or 4 are denoted by the same reference numerals as used in FIG. 2 or 4.

The storage section 110 stores various types of data. The storage section 110 temporarily stores the curve A data and the curve B data.

The personal target response curve data generation section 118 reads the curve A data and the curve B data from the storage section 110, adds the amplitude frequency characteristic represented by the curve A data and the amplitude frequency characteristic represented by the curve B data, and generates curve X data representing the resulting amplitude frequency characteristic. The curve X data generated by the personal target response curve data generation section 118 is stored in the storage section 110. The curve X data generated in this manner represents the target response curve for the test listener involved in the generation of the curve X data.

The curve X represented by the curve X data generated as described above most effectively functions as a reference target response curve when used with an external auditory canal sound emitting device of the same type as the one used in the generation of the curve X data (including the actual device used in its generation). However, it is also acceptable for the curve X data to be used as the reference target response curve for a different type of external auditory canal sound emitting device than the one used in its generation.

FIG. 8 shows a processing flow performed by the computer 11 functioning as a device with the above configuration, for generating the curve X data. That is, the computer 11 (personal target response curve data generation section 118) adds the amplitude frequency characteristics represented by the curve A data and the curve B data and generates the curve X data (step S301). The computer 11 (storage section 110) stores the curve X data generated at step S301. Thereafter, the computer 11 completes the processing for generating the curve X data.

It is of note that in the curve X, the absolute values of the amplitude for each frequency are not of significant importance; rather, the relative values, i.e., the relative relationships among the amplitude values of each frequency, are meaningful of significance.

### (4) Generation of Curve Y Data

The following describes the operation performed by the target response curve data generation system 1 to generate the curve Y data.

First, the curve Y data is generated using the curve X data individually generated for each of a plurality of test listeners. Therefore, prior to the generation of the curve Y data, the generation of the above-described curve A data, curve B data, and curve X data must be executed for each of the plurality of test listeners.

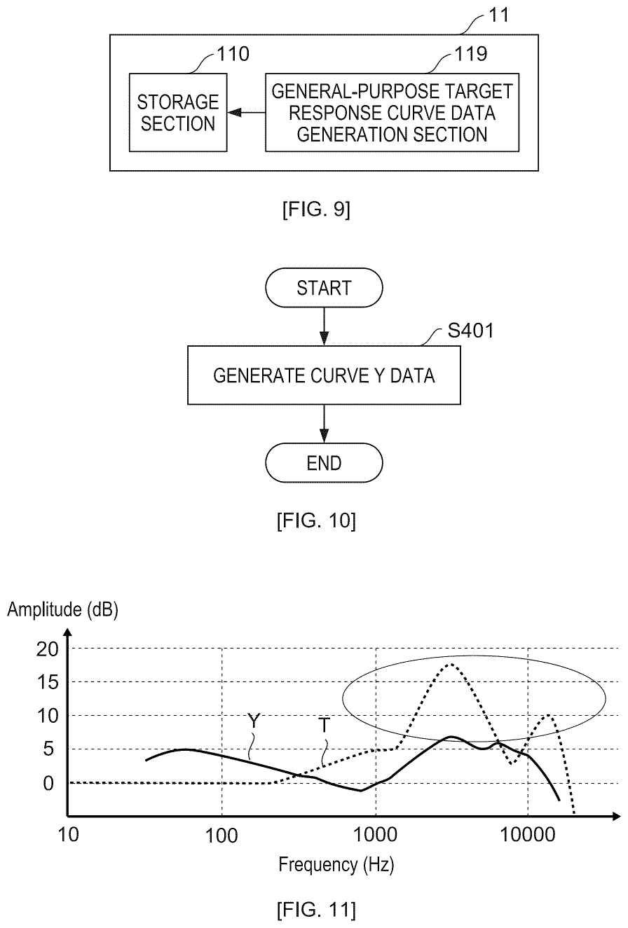

FIG. 9 shows the configuration of a data processing device (an example of a target response curve data generation system) implemented by the computer 11 for generating the curve Y data. That is, the computer 11 functions as a device having the components shown in FIG. 9 by executing data processing according to a program for generating the curve Y data.

The components shown in FIG. 9 will be described below. In FIG. 9, components common to those shown in FIGS. 2, 4, or 7 are denoted by the same reference numerals as used in FIGS. 2, 4, or 7.

The storage section 110 stores various types of data. The storage section 110 stores curve X data for each of a plurality of test listeners.

The general-purpose target response curve data generation section 119 reads multiple curve X data from the storage section 110, and generates curve Y data representing the amplitude frequency characteristic obtained by averaging the amplitude frequency characteristics represented by the curve X data. The curve Y data generated by the general purpose target response curve data generation section 119 is stored in the storage section 110. The curve Y data generated in this manner represents a target response curve for general purpose use, i.e., for any listener.

FIG. 10 shows a processing flow performed by the computer 11 functioning as a device with the above configuration, for generating the curve Y data. That is, the computer 11 (general purpose target response curve data generation section 119) averages the amplitude frequency characteristics represented by the curve X data for each of the plurality of test listeners and generates the curve Y data (step S401). The computer 11 (storage section 110) stores the curve Y data generated at step S401. Thereafter, the computer 11 completes the processing for generating the curve Y data.

It is of note that in the curve Y, the absolute values of the amplitude for each frequency are not of significant importance; rather, the relative values, i.e., the relative relationships among the amplitude values of each frequency, are meaningful of significance.

By the above-described processing by the target response curve data generation system 1, curve X data representing the target response curve for each test listener is generated. In addition, by the above-described processing by the target response curve data generation system 1, curve Y data representing the target response curve for any listener is also generated.

The curve Y represented by the curve Y data generated as described above is most effective when used as the reference target response curve for an external auditory canal sound emitting device of the same type as that used to generate the curve X data (including the exact same device). However, the curve Y may also be used as the reference target response curve for a different type of external auditory canal sound emitting device than the one used in generating the curve X data.

The curve X data generated by the processing of the target response curve data generation system 1 as described above represents the curve X for each of the left and right ears of an individual test listener. However, for many test listeners, the curves X for each of the left and right ears are similar. Therefore, the curve X data may represent the curve X for only one of the ears of the test listener. Alternatively, the curve X data may represent a curve X obtained by averaging the curves X for both ears of the test listener. However, in the case of a test listener for whom curves X for the left and right ears differ significantly, it is preferable to use the individual curves X for each ear respectively.

Similarly, the curve Y data generated by the processing of the target response curve data generation system 1 also represents the curve Y for each of the left and right ears. However, the curve Y obtained by averaging the curves X for the left ears of many test listeners and the curve Y obtained by averaging the curves X for the right ears of many test listeners are generally similar. Therefore, the curve Y data may represent the curve Y for only one of the ears. Alternatively, the curve Y data may represent a curve Y obtained by averaging the curves Y for both ears.

Experiments have confirmed that immersive binaural sound emitted by headphones or earphones manufactured with curve Y as a reference achieves higher reproducibility of spatial impression, i.e., sound image localization and spatial width or listener envelopment (LEV), compared to immersive binaural sound emitted by conventional, headphones or earphones.

When immersive binaural sound is emitted by headphones or earphones manufactured with curve X as a reference, and listened to by the test listener who was involved in the generation of that curve X, the above-described effects of curve Y are even more prominent.

The above-described curve X or curve Y is a target response curve in which acoustic characteristics are defined so as to remove components contributing to the perception of sound directionality generated by an outer shape of a human body, including at least a head, while maintaining timbre recognition characteristics in the human brain.

In other words, the external auditory canal sound emitting device having an amplitude frequency characteristic according to curve X or curve Y emits sound that reduces only the position information (spatial blanking) while retaining the timbre information contained in the input spatial sound.

Curve A is the amplitude frequency characteristic observed proximate to the eardrum of the test listener when wearing any headphones or earphones. Curve B is solely intended to enable the listener to correctly perceive timbre, and serves to compensate for the amplitude frequency characteristics of the worn headphones or earphones. It is important to note that curve B does not contain any information relating to human perception of sound directionality. Therefore, the target response curve data generation system 1 adds the curves A and B to remove the components contributing to perception of sound directionality generated by the outer shape of the human body, including at least the head, and to define a target response curve (curve X or curve Y) that retains timbre recognition characteristics in the human brain, thereby generating target response curve data representing the target response curve.

FIG. 11 is a graph showing curve Y and a target response curve T created based on an anechoic chamber as a reference.

In FIG. 11, the portion of the target response curve T enclosed by an ellipse serves to emphasize position information and impart a sense of spatiality to two-channel stereo sound. Immersive binaural sound already contains position information that imparts spatiality. Therefore, if immersive binaural sound is emitted by an external auditory canal sound emitting device with an amplitude frequency characteristic according to target response curve T, unnecessary emphasis of position information will occur. As a result, the sound image localization direction and sense of distance in three-dimensional space of the sound source, the spatial breadth (left-right, front-back, up-down), directional feel, and sense of distance arising from combinations of multiple sound sources (composite sound sources), as well as the sense of spatial spread due to reflected sound, may not be reproduced as originally intended by the creator of the sound source. This issue commonly occurs with conventional target response curves such as the Harman target response curve, which are intended for listening to two-channel stereo sound.

On the other hand, if immersive binaural sound is emitted by an external auditory canal sound emitting device with an amplitude frequency characteristic according to curve Y (or curve X), unnecessary emphasis of position information, as described above, does not occur. At the same time, the timbre information remains almost unchanged due to the amplitude frequency characteristic derived from loudness adjustments performed by the test listener. As a result, the sound image localization direction and sense of distance in three-dimensional space of the sound source, the spatial breadth (left-right, front-back, up-down), directional feel, and sense of distance arising from combinations of multiple sound sources (composite sound sources), as well as the sense of spatial spread due to reflected sound, can be reproduced as originally intended by the creator of the sound source.

The above explains the target response curve data generation system 1.

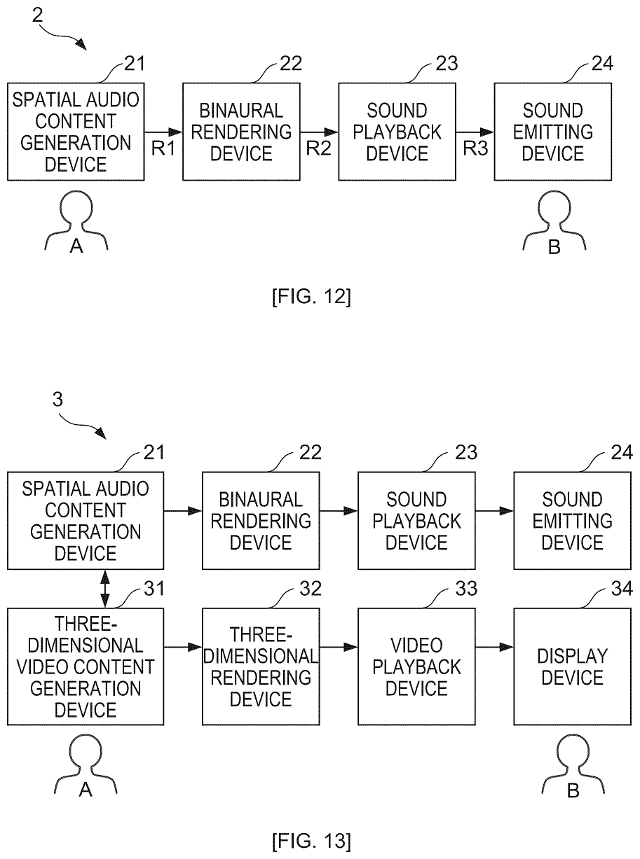

FIG. 12 shows the configuration of an acoustic system 2 that uses the target response curve data (curve X data or curve Y data) generated by the target response curve data generation system 1.

The acoustic system 2 includes a spatial audio content generation device 21, a binaural rendering device 22, a sound playback device 23, and a sound emitting device 24.

The spatial audio content generation device 21 (a generation section, and an example of a spatial audio content generation section) is a device used by creator A to produce spatial audio content. The spatial audio content generation device 21 may consist of multiple cooperating devices.

The spatial audio content data representing the spatial audio content generated by the spatial audio content generation device 21 includes, for each of a plurality of sound sources, sound source position data representing the sound source position of that sound source and sound data representing the sound emitted by that sound source.

The method by which the spatial audio content generation device 21 generates the spatial audio content may be any of the following: a channel-based method, an object-based method, or a combination thereof.

The spatial audio content data generated by the spatial audio content generation device 21 is delivered to the binaural rendering device 22 via a transmission path R1. The transmission path R1 may take any form, including wired, wireless, communication networks, recording media, or any combination thereof. Furthermore, the spatial audio content generation device 21 and the binaural rendering device 22 may be integrally configured. In that case, the transmission path R1 is constituted of signal lines within the device.

The binaural rendering device 22 (an example of a binaural rendering section) is a device that generates immersive binaural sound, which is two-channel spatial sound, by using the spatial audio content represented by the spatial audio content data generated by the spatial audio content generation device 21 and a head-related transfer function. It is of note that the binaural rendering device 22 may be composed of a group of cooperating devices.

The immersive binaural sound data generated by the binaural rendering device 22 is delivered to the sound playback device 23 via a transmission path R2. The transmission path R2 may be of any form, including wired, wireless, communication networks, recording media, or a combination thereof. Additionally, the binaural rendering device 22 and the sound playback device 23 may be integrally configured. In that case, the transmission path R2 is constituted of signal lines within the device.

The sound playback device 23 (an example of a sound emission section) is a device that sequentially outputs to the sound emitting device 24 the immersive binaural sound data generated by the binaural rendering device 22, or the immersive binaural sound signal obtained by D/A converting the immersive binaural sound data, at a speed corresponding to the playback speed of the immersive binaural sound.

The sound data or audio signal is output from the sound playback device 23 to the sound emitting device 24 via a transmission path R3. The transmission path R3 may take any form, including wired, wireless, communication networks, or a combination thereof.

The sound emitting device 24 is a device that actually emits sound proximate to the external auditory canal of listener B, or simulates emission of sound proximate to the external auditory canal of listener B.

Examples of sound emitting devices 24 that actually emit sound proximate to the external auditory canal of the listener B include headphones, earphones, and headrest speakers. The term “headrest speakers” refers to speakers one each disposed on a left side and a right side of a headrest portion of a chair, or refers to a chair equipped with such speakers. Headrest speakers are used, for example, in seats of automobiles or in gaming chairs.

An example of a sound emitting device 24 that simulates emission of sound proximate to the external auditory canal of listener B is a speaker system that generates virtual sound proximate to the external auditory canal of listener B using multiple speakers such as a speaker array.

The sound emitting device 24 sequentially receives immersive binaural sound data, which is digital data, from the sound playback device 23, and emits sound according to an analog signal obtained by D/A converting the received immersive binaural sound data. Alternatively, the sound emitting device 24 sequentially receives an immersive binaural sound signal, which is an analog signal, from the sound playback device 23 and emits sound according to the received immersive binaural sound signal.

The curve X data or curve Y data generated by the target response curve data generation system 1 may be used in any of the following modes, for example.
(a) The sound emitting device 24 is designed and manufactured such that, due to its physical characteristics, it emits sound having an amplitude frequency characteristic that conforms to the target response curve represented by the curve X data or the curve Y data.
(b) The sound emitting device 24 includes a sound correction section that corrects the sound data or the audio signal received from the sound playback device 23 in accordance with the target response curve indicated by the curve X data or the curve Y data, and emits sound corresponding to the corrected sound data or audio signal.
(c) The sound playback device 23 includes a sound correction section that corrects the sound data received from the binaural rendering device 22 in accordance with the target response curve represented by the curve X data or the curve Y data, and outputs to the sound emitting device 24 either the corrected sound data or an audio signal obtained by D/A converting the corrected sound data.
(d) The binaural rendering device 22 includes a sound correction section that corrects the sound data included in the spatial audio content data received from the spatial audio content generation device 21 in accordance with the target response curve represented by the curve X data or the curve Y data, and uses the corrected sound data to perform binaural rendering and generate sound data, which is then sent to the sound playback device 23.
(e) The binaural rendering device 22 includes a sound correction section that corrects the sound data generated by performing binaural rendering using the sound data included in the spatial audio content data received from the spatial audio content generation device 21, in accordance with the target response curve represented by the curve X data or the curve Y data, and sends the corrected sound data to the sound playback device 23.
(f) The spatial audio content generation device 21 includes a sound correction section that corrects the sound data generated under instruction of a creator A in accordance with the target response curve indicated by the curve X data or the curve Y data, and sends to the binaural rendering device 22 the spatial audio content data including the corrected sound data.
(g) The acoustic system 2 includes a sound processing device (not shown in FIG. 12) disposed in the transmission path R1, transmission path R2, or transmission path R3. The sound processing device includes a sound correction section that applies correction, in accordance with the target response curve represented by the curve X data or the curve Y data, to the sound data or audio signal input from an upstream device in the transmission path, and outputs the corrected sound data or audio signal to a downstream device in the transmission path.

The sound emitting device 24 of the acoustic system 2 can serve as an acoustic display since it emits sound that enables a listener B to accurately perceive the position of the sound source.

The above is a description of the acoustic system 2.

### Modifications

The embodiments described above are merely examples of the present invention, and may be modified in various ways within the scope of the technical concept of the present invention. Below are examples of such modifications. It is of note that two or more of the following modifications may be combined, as appropriate.
(1) Among the devices included in the acoustic system 2 described above, the device that applies correction to the input sound in accordance with the target response curve represented by the curve X data or the curve Y data may be implemented by a computer. In that case, the computer executes a process for applying correction to the input sound in accordance with the target response curve represented by the curve X data or the curve Y data, in accordance with a program corresponding to the present invention.

That is, one aspect of the present invention provides a program that causes a computer to execute a process for applying correction to the input sound in accordance with the target response curve represented by the curve X data or the curve Y data. Another aspect of the present invention provides a recording medium on which such a program is recorded. Yet another aspect of the present invention provides a computer comprising a memory that non-transitorily stores such a program and a processor that performs data processing in accordance with the program non-transitorily stored in the memory.

For example, when the spatial audio content generation device 21 is implemented by a computer operating in accordance with a Digital Audio Workstation (DAW) program, the program for executing the correction to the input sound in accordance with the target response curve represented by the curve X data or the curve Y data may be provided as plug-in software incorporated in the DAW program.
(2) The method by which any of the devices included in the acoustic system 2 described above performs correction to the input sound in accordance with the target response curve represented by the curve X data or the curve Y data may employ equalization processing, use of a finite impulse response (FIR) filter, or any other appropriate method.
(3) One aspect of the present invention provides sound data representing sound obtained by applying correction to a source sound in accordance with the target response curve represented by the curve X data or the curve Y data. Another aspect of the present invention provides a recording medium on which such sound data is recorded.
(4) The acoustic system 2 may be modified to include a video generation device that generates video of a three-dimensional space in cross reality (such as virtual reality, augmented reality, mixed reality, or alternative reality), and a display device that displays the video generated by the video generation device. In this configuration, the binaural rendering device 22 generates spatial audio content using sound sources corresponding to objects within the three-dimensional space of the generated video, thereby providing an audiovisual system.

FIG. 13 shows the configuration of the audiovisual system 3 according to this modification. The audiovisual system 3 includes, in addition to the spatial audio content generation device 21, binaural rendering device 22, sound playback device 23, and sound emitting device 24 provided in the acoustic system 2, a three-dimensional video content generation device 31, a three-dimensional rendering device 32, a video playback device 33, and a display device 34.

The three-dimensional video content generation device 31 (an example of a video generation section) is a device that generates three-dimensional video content data representing the position, three-dimensional shape, appearance, etc., of objects (people or things) in the three-dimensional space of the cross reality.

The three-dimensional rendering device 32 generates a two-dimensional video from a viewpoint of a viewer, based on the three-dimensional video content data created by the three-dimensional video content generation device 31. This process is referred to as a three-dimensional rendering process.

The video playback device 33 sequentially outputs the two-dimensional video generated by the three-dimensional rendering device 32 to the display device 34.

The display device 34 (an example of a display section) displays the two-dimensional video output from the video playback device 33.

The spatial audio content data generated by the spatial audio content generation device 21 represents, for each sound source in the three-dimensional space, the position of the sound source and the sound emitted by the sound source. The three-dimensional video content data generated by the three-dimensional video content generation device 31 represents, for each object in the three-dimensional space, the position, shape, and appearance of the object.

The coordinate system of the three-dimensional space used by the spatial audio content generation device 21 matches that used by the three-dimensional video content generation device 31. Furthermore, the sound source handled by the spatial audio content generation device 21 corresponds to one of the objects handled by the three-dimensional video content generation device 31. That is, when a certain object shared between both devices serves as a sound source, a position of that object handled by the video device and a position of the sound source handled by the audio device are identical.

As described above, since the spatial audio content generation device 21 and the three-dimensional video content generation device 31 share position information for the same object (sound source) within the same coordinate space, the sound emitted from the sound emitting device 24 and the video displayed by the display device 34 are synchronized. In other words, when an object in the three-dimensional space shown in the video emits a sound, the sound is perceived by the viewer B as originating from the position of that object.

In the audiovisual system 3, the sound emitted to the viewer B is sound with an amplitude frequency characteristic in accordance with the target response curve indicated by the curve X data or the curve Y data. Accordingly, the viewer B can accurately perceive the position of the sound source within the virtual three-dimensional space.

The audiovisual system 3 is particularly effective in fields such as gaming and telemedicine, where it is essential that a position of a sound source, synchronized with video, is accurately conveyed to a viewer.

The display device 34 may be a wearable device such as a head-mounted display. In such a case, data representing the position and orientation of the head of viewer B wearing the head-mounted display (i.e., the viewer's viewpoint) is provided to the binaural rendering device 22 and the three-dimensional rendering device 32. The data is used for generating sound by the binaural rendering device 22 and generating video by the three-dimensional rendering device 32. Consequently, viewer B can perceive sound and video that change according to their head movements.
(5) In the acoustic system 2 described above, the spatial audio content generation device 21 may continuously acquire the position of a moving sound source and generate spatial audio content representing the acquired position of the sound source. In such a case, listener B can accurately perceive the constantly changing position of the moving sound source in the three-dimensional space.

In this modification, the sound emitting device 24 may emit sound proximate to the external auditory canal of listener B, who moves together with the moving sound source. For example, if listener B is a musical instrument player wearing the sound emitting device 24 as an in-ear monitor, position data representing a location of each of a musical instrument player including the listener B, and sound data representing a sound emitted by each instrument, are transmitted in real time to the spatial audio content generation device 21. Using this data, the device generates spatial audio content data. As a result, listener B can perform while accurately perceiving the positions of other musical instrument players by way of the sound emitted from the sound emitting device 24.
(6) In the target response curve data generation system 1 described above, the computer 11 (general-purpose target response curve data generation section 119) may determine curve Y as the amplitude frequency characteristic obtained by averaging the amplitude frequency characteristics represented by the curve X data of multiple test listeners. Alternatively, curve Y may be determined by averaging the curve A data and the curve B data respectively obtained from multiple test listeners, and then summing the results. The test listeners involved in generating curve A data and curve B data may be the same or different.

Alternatively, the computer 11 may sum the amplitude frequency characteristics represented by the curve A data of multiple test listeners, and also the same number of additional curve A data sets from different test listeners, and then average the total to determine curve Y. The test listeners involved in generating the curve A data and those involved in the additional curve A data may be the same or different. According to this modification, individual curve X, general purpose curve A, and general purpose curve B are not specified in determining curve Y.
(7) Among the devices included in the acoustic system 2 described above, a device that performs correction based on the target response curve represented by curve X data or curve Y data may include an acquisition section for obtaining the curve X data or the curve Y data and a storage section for storing the acquired data. The correction may be performed on the input sound in accordance with the target response curve stored in the storage section.

According to this modification, for example, the sound emitting device 24 including a sound correction section can be customized for listener B by storing curve X data corresponding to listener B. If curve Y data differs based on attributes such as the listener's gender, ethnicity, or age, the device can also be customized by storing the appropriate curve Y data. The same applies to other devices that include a sound correction section.
(8) In the embodiment described above, the test sound used to generate curve A data is assumed to be band-limited pink noise that divides full audible range pink noise into multiple frequency bands. However, the test sound is not limited thereto.

For example, an impulse may be used as the test sound for generating curve A data. In that case, the computer 11 (curve A data generation section 114) determines curve A as the amplitude frequency characteristic of the impulse response. Using an impulse shortens the time required by the test listener, making it advantageous for reducing a burden on the listener.

Alternatively, a sweep signal whose frequency continuously or intermittently changes within the audible range may be used as the test sound. In such a case, the combination of the sweep signal's frequency emitted by headphones 13 and the amplitude of the corresponding sound captured by microphone 14 can be obtained over the full audible range. The curve A data generation section 114 uses these combinations to determine curve A. By adjusting a sweep speed (for continuous sweeps) or a frequency interval (for intermittent sweeps), it is possible to balance a measurement time and accuracy. For example, if a test listener desires a highly accurate personal curve A (or a curve X based on it), the sweep speed may be slowed or the frequency interval reduced.

In the embodiment described above, the test sound used for generating curve A data is a set of band-limited pink noises for each one-third octave frequency band. Since the same type of band-limited pink noise is used to generate curve B data, this is advantageous for preparing test sounds. Additionally, when generating curve B data, band-limited pink noise tends to produce more accurate curve A data than an impulse, and generally requires less time than using a sweep signal.
(9) In the above embodiment, the frequency band of the band-limited pink noise used as the reference for generating curve B data was assumed to be centered at 500 Hz. However, the frequency band is not limited thereto. That is, a band-limited pink noise centered at a frequency other than 500 Hz may be used as the reference frequency band for generating curve B data.

Also, in the above embodiment, the reference sound pressure of the band-limited pink noise played to the test listener for generating curve B data is assumed to be 65 dB PSL. However, the sound pressure is not limited thereto. That is, a band-limited pink noise having a reference sound pressure other than 65 dB PSL may be used for generating curve B data.

Furthermore, in the above embodiment, the bandwidth of each frequency band of the multiple band-limited pink noise played sequentially to the test listener for generating curve A data and curve B data is assumed to be one-third octave. However, the octave division is not limited thereto. That is, pink noise of a frequency band with a one-mth octave bandwidth (where m is any positive integer) may be used for generating curve A data or curve B data.

1-64. (canceled)

65. A method for generating target response curve data, wherein acoustic characteristics are configured to remove components contributing to a perception of sound directionality generated by an outer shape including at least a head of a human, and to maintain timbre recognition characteristics recognized by the human brain, comprising:
a step of acquiring acoustic characteristics of sound from an external auditory canal through to an eardrum of a test listener;
a step of acquiring sound pressure adjustment characteristics whereby the test listener perceives a loudness of sound as uniform across a full audible range; and
a step of generating target response curve data based on the acoustic characteristics and the sound pressure adjustment characteristics.

66. The method for generating target response curve data according to claim 65,
wherein the step of acquiring the acoustic characteristics includes generating curve A data representing an amplitude frequency characteristic of sound picked up proximate to the eardrum of the test listener while test sound is emitted proximate to the external auditory canal of the test listener;
the step of acquiring the sound pressure adjustment characteristics includes generating curve B data representing an amplitude frequency characteristic based on variation amounts in sound pressure across a plurality of frequency bands, wherein the test listener adjusts a sound pressure of each of the plurality of frequency bands other than a reference frequency band so that each of the plurality of frequency bands is perceived to have a same loudness as that of the reference frequency band when band-limited pink noise obtained by dividing full audible range pink noise is sequentially emitted at a reference sound pressure proximate to the external auditory canal of the test listener; and
the step of generating the target response curve data includes generating curve X data representing an amplitude frequency characteristic obtained by adding the amplitude frequency characteristic represented by the curve A data and the amplitude frequency characteristic represented by the curve B data, as the target response curve data for the test listener.

67. The method for generating target response curve data according to claim 66, further comprising:
a step of generating curve Y data, as general purpose target response curve data, by averaging the amplitude frequency characteristics represented by the curve X data generated for each of a plurality of test listeners.

68. The method for generating target response curve data according to claim 65,
wherein the step of acquiring the acoustic characteristics includes, for each of the plurality of test listeners, generating curve A data representing an amplitude frequency characteristic of sound picked up proximate to the eardrum of the test listener while test sound is emitted proximate to the external auditory canal of the test listener, and generating general purpose curve A data by averaging the amplitude frequency characteristics represented by the generated curve A data;
the step of acquiring the sound pressure adjustment characteristics includes, for each of the plurality of test listeners, generating curve B data representing an amplitude frequency characteristic based on variation amounts in sound pressure across a plurality of frequency bands, wherein the test listener adjusts the sound pressure of each of the plurality of frequency bands other than a reference frequency band so that each of the plurality of frequency bands is perceived to have the same loudness as that of the reference frequency band when band-limited pink noise obtained by dividing full audible range pink noise is sequentially emitted at a reference sound pressure proximate to the external auditory canal of the test listener, and generating general-purpose curve B data by averaging the amplitude frequency characteristics represented by the generated curve B data; and
the step of generating the target response curve data includes generating curve Y data, as general purpose target response curve data, representing an amplitude frequency characteristic obtained by adding the amplitude frequency characteristic represented by the general purpose curve A data and the amplitude frequency characteristic represented by the general purpose curve B data.

69. The method for generating target response curve data according to claim 65,
wherein the step of acquiring acoustic characteristics includes generating curve A data representing an amplitude frequency characteristic of sound picked up proximate to the eardrum of the test listener while test sound is emitted proximate to the external auditory canal of the test listener by an external auditory canal sound emitting device;
the step of acquiring sound pressure adjustment characteristics includes generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data, the test listener adjusts the sound pressure of each of the plurality of frequency bands other than a reference frequency band so that each of the plurality of frequency bands is perceived to have the same loudness as that of the reference frequency band; and
the step of generating the target response curve data includes generating curve X data representing an amplitude frequency characteristic obtained by adding the amplitude frequency characteristic represented by the curve A data and the amplitude frequency characteristic represented by the curve B data, as target response curve data for the same or similar type of external auditory canal sound emitting device used in generating the curve A data and the curve B data for the test listener.

70. The method for generating target response curve data according to claim 69, further comprising:
a step of generating curve Y data, as general purpose target response curve data for the same or similar type of external auditory canal sound emitting device used in generating the curve X data, by averaging the amplitude frequency characteristics represented by the curve X data generated for each of a plurality of test listeners.

71. The method for generating target response curve data according to claim 65,
wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener by an external auditory canal sound emitting device, and generating general purpose curve A data by averaging the amplitude frequency characteristics represented by the generated curve A data;
the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data, the test listener adjusts the sound pressure of each of the plurality of frequency bands other than a reference frequency band so that each of the plurality of frequency bands is perceived to have the same loudness as that of the reference frequency band, and generating general purpose curve B data by averaging the amplitude frequency characteristics represented by the generated curve B data; and
the step of generating the target response curve data includes generating curve Y data representing an amplitude frequency characteristic obtained by adding the amplitude frequency characteristic represented by the general purpose curve A data and the amplitude frequency characteristic represented by the general purpose curve B data, as general purpose target response curve data for the same or similar type of external auditory canal sound emitting device used in generating the curve A data and the curve B data.

72. The method for generating target response curve data according to claim 65,
wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener;
the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing full audible range pink noise is sequentially emitted at a reference sound pressure proximate to the external auditory canal of the test listener, the test listener adjusts the sound pressure of each of the plurality of frequency bands other than a reference frequency band so that each of the plurality of frequency bands is perceived to have the same loudness as that of the reference frequency band; and
the step of generating the target response curve data includes generating curve Y data representing an amplitude frequency characteristic obtained by adding all the amplitude frequency characteristics represented by the curve A data and the curve B data of each of the plurality of test listeners and averaging the sum by the number of test listeners, as general purpose target response curve data.

73. The method for generating target response curve data according to claim 65,
wherein the step of acquiring acoustic characteristics includes, for each of a plurality of test listeners, generating curve A data representing an amplitude frequency characteristic of sound picked up proximate to the eardrum of the test listener while test sound is emitted proximate to the external auditory canal of the test listener by an external auditory canal sound emitting device;
the step of acquiring sound pressure adjustment characteristics includes, for each of the plurality of test listeners, generating curve B data representing an amplitude frequency characteristic based on variation amounts in sound pressure across a plurality of frequency bands, wherein, when band-limited pink noise obtained by dividing the full audible range pink noise is sequentially emitted at a reference sound pressure proximate to the external auditory canal of the test listener using the same external auditory canal sound emitting device used to generate the curve A data, the test listener adjusts the sound pressure of each of the plurality frequency bands other than a reference frequency band so that each of the plurality of frequency bands is perceived to have the same loudness as that of the reference frequency band; and
the step of generating the target response curve data includes generating curve Y data representing an amplitude frequency characteristic obtained by adding all the amplitude frequency characteristics represented by the curve A data and the curve B data of each of the plurality of test listeners and averaging the sum by the number of test listeners, as general purpose target response curve data for the same or similar type of external auditory canal sound emitting device used in generating the curve A data and the curve B data.

74. The method for generating target response curve data according to claim 66,
wherein the test sound is one of:
band-limited pink noise obtained by dividing the full audible range pink noise into a plurality of frequency bands;
an impulse; or
a sweep signal in which the frequency changes continuously or intermittently within the full audible range.

75. The method for generating target response curve data according to claim 66,
wherein the reference frequency band is a frequency band centered at 500 Hz.

76. The method for generating target response curve data according to claim 66,
wherein the reference sound pressure is 65 dB PSL.

77. The method for generating target response curve data according to claim 66,
wherein the bandwidth of each of the plurality of frequency bands is one-third octave.

78. The method for generating target response curve data according to claim 68,
wherein the test sound is one of:
band-limited pink noise obtained by dividing the full audible range pink noise into a plurality of frequency bands;
an impulse; or
a sweep signal in which the frequency changes continuously or intermittently within the full audible range.

79. The method for generating target response curve data according to claim 68,
wherein the reference frequency band is a frequency band centered at 500 Hz.

80. The method for generating target response curve data according to claim 68,
wherein the reference sound pressure is 65 dB PSL.

81. The method for generating target response curve data according to claim 68,
wherein the bandwidth of each of the plurality of frequency bands is one-third octave.

82. The method for generating target response curve data according to claim 69,
wherein the test sound is one of:
band-limited pink noise obtained by dividing the full audible range pink noise into a plurality of frequency bands;
an impulse; or
a sweep signal in which the frequency changes continuously or intermittently within the full audible range.

83. The method for generating target response curve data according to claim 69,
wherein the reference frequency band is a frequency band centered at 500 Hz.

84. The method for generating target response curve data according to claim 69,
wherein the reference sound pressure is 65 dB PSL.

85. The method for generating target response curve data according to claim 69,
wherein the bandwidth of each of the plurality of frequency bands is one-third octave.

86. The method for generating target response curve data according to claim 71,
wherein the test sound is one of:
band-limited pink noise obtained by dividing the full audible range pink noise into a plurality of frequency bands;
an impulse; or
a sweep signal in which the frequency changes continuously or intermittently within the full audible range.

87. The method for generating target response curve data according to claim 71,
wherein the reference frequency band is a frequency band centered at 500 Hz.

88. The method for generating target response curve data according to claim 71,
wherein the reference sound pressure is 65 dB PSL.

89. The method for generating target response curve data according to claim 71,
wherein the bandwidth of each of the plurality of frequency bands is one-third octave.

90. The method for generating target response curve data according to claim 72,
wherein the test sound is one of:
band-limited pink noise obtained by dividing the full audible range pink noise into a plurality of frequency bands;
an impulse; or
a sweep signal in which the frequency changes continuously or intermittently within the full audible range.

91. The method for generating target response curve data according to claim 72,
wherein the reference frequency band is a frequency band centered at 500 Hz.

92. The method for generating target response curve data according to claim 72,
wherein the reference sound pressure is 65 dB PSL.

93. The method for generating target response curve data according to claim 72,
wherein the bandwidth of each of the plurality of frequency bands is one-third octave.

94. The method for generating target response curve data according to claim 73,
wherein the test sound is one of:
band-limited pink noise obtained by dividing the full audible range pink noise into a plurality of frequency bands;
an impulse; or
a sweep signal in which the frequency changes continuously or intermittently within the full audible range.

95. The method for generating target response curve data according to claim 73,
wherein the reference frequency band is a frequency band centered at 500 Hz.

96. The method for generating target response curve data according to claim
wherein the reference sound pressure is 65 dB PSL.

97. The method for generating target response curve data according to claim 73,
wherein the bandwidth of each of the plurality of frequency bands is one-third octave.
